(19) United States
(12) Patent Application Publication
(10) Pub. No.: US 2003/0075032 A1
(43) Pub. Date: Apr. 24, 2003

(54) Cue stick tip shaping and reconditioning device

(76) Inventor: Joseph Porper, Chatsworth, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/021,487

(22) Filed: Oct. 22, 2001

(51) Int. Cl. B23D 21/06

(52) U.S. Cl. 83/195; 83/178; 30/92

(57) ABSTRACT

A device for shaping and reconditioning a cue stick tip includes a hand-held housing defining a bore having an open end configured to receive the tip of the cue stick. A cutter includes a shaft extending outward of an aperture of the housing opposite the open end, and two blades. Each blade is curved upwardly from a center line thereof to form a concave cutting edge. A handle is removably connected to the cutter for manually rotating the cutter. The cutter forms a convex shape to the tip of the cue stick when the tip is placed into contact with the cutter and the cutter is rotated.

### BACKGROUND OF THE INVENTION

The present invention generally relates to cue sticks used in the game of billiards. More particularly, the present invention relates to a device that shapes and reconditions the tip of a billiard cue stick.

A cue stick is typically made of wood, such as ash or maple, having a length of approximately five feet. The cue stick tapers to a relatively small diameter hitting end. To such end there is assembled, typically by a form of adhesive, a short and rounded tip typically made of an impressionable material such as leather. The purpose of the tip is to facilitate striking a cue ball with a cue stick. Most tips are purchased in a substantially preformed condition. The tip permits the cue ball to be pressed into the leather to better engage the free end of the cue stick to the cue ball. Another purpose for the tip is to protect the cue ball from nicks and scratches. Other purposes for the cue tip are to impart a “spin” to a cue ball and to enhance the velocity with which a cue ball may be driven. The tip also protects the end of a cue stick from splintering upon impact with a cue ball.

The high interest in which billiard games have held for the public over a period of many years has in part been the result of the precision shots which highly skilled play brings about. These, in turn, rely on accurately placed impacts of the cue stick on the cue ball. During the game, chalk is regularly applied to the cue tip which serves as an adhesive so the cue stick will strike the ball without miscuing. A properly shaped and chalked leather tip ensures that the contact will occur at a desired point on the cue ball without slippage.

However, a persistent problem occurs that the chalk becomes hardened and glazed over the end of the cue tip after substantial use. The chalk no longer is retained on the tip or serves as an adhesive as the cue tip will not accept the chalk, causing miscuing. Another persistent problem is that the cue tip is constantly subjected to strong impacts and may be used improperly occasionally, resulting in the impressionable cue tip becoming deformed or otherwise damaged.

Accordingly, there is a need for a device which can conveniently, rapidly, and inexpensively shape and recondition the tip of a cue stick. The present invention fulfills these needs and provides other related advantages.

### SUMMARY OF THE INVENTION

The present invention resides in a device for shaping and re-conditioning the tip of a cue stick. The device comprises a hand-held housing defining a bore configured to receive the tip of the cue stick. Typically, the housing is generally cylindrical in shape and includes a roughened exterior surface to facilitate manual gripping. The housing may also include a guide insert disposed within the bore adjacent to an open end of the housing. The insert may be comprised of plastic, or similar material, to prevent scratching, marring, etc. of the cue tip as it is introduced into the bore.

A cutter is disposed within the bore to engage the tip of the cue stick. The cutter forms a convex shape to the tip of the cue stick when the tip is placed in contact with the cutter and the cutter is rotated. The cutter comprises a bit having a shaft extending outward of an aperture of the housing opposite an open end thereof, and a blade opposite the shaft for shaping the cue stick tip. Typically, the blade comprises two blades, each blade being curved upwardly from a center line of the bit so that the two blades cooperatively form a concave cutting edge which imparts the convex shape to the cue stick tip.

A handle is connected to the cutter for manually rotating the cutter. Typically, the handle is removably attached to the cutter by a screw inserted through an aperture of the handle and into a recess of the cutter's shaft. This allows the cutter to be removably disposed within the housing so that it can be sharpened or replaced as necessary.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a device embodying the present invention for shaping and reconditioning tips of cue sticks, and having a cue stick tip, illustrated in phantom, inserted therein for shaping;

FIG. 2 is a partially exploded perspective view of the device of FIG. 1, illustrating the removable nature of a cutter and handle thereof with the use of an allen wrench;

FIG. 3 is an enlarged perspective view of the cutter of FIG. 2;

FIG. 4 is a plan view taken generally along line 4-4 of FIG. 3, illustrating two blades of the cutter;

FIG. 5 is a cross-sectional view taken generally along line 5-5 of FIG. 1, illustrating the various component parts of the device, and a removable set screw used to connect the cutter with the handle; and

FIG. 6 is a cross-sectional view similar to FIG. 5, illustrating a cue stick tip inserted into the device, and the rotation of the cutter to shape and recondition the tip.

### DETAILED DESCRIPTION OF THE PREFERRED EMBODIMENT

As shown in the drawings for purposes of illustration, the present invention is concerned with a device 10 for shaping and reconditioning a tip of a cue stick 12 in a rapid, easy and inexpensive manner. A cue stick 12, as described above, includes an impressionable tip 14 comprised of leather or other material that is suited to accept chalk and accurately strike a cue ball. Such tips 14 periodically require reshaping and reconditioning due to hardened chalk formed thereon, or compression and deformation of the surface of the tip 14 which can create miscuing when striking a ball.

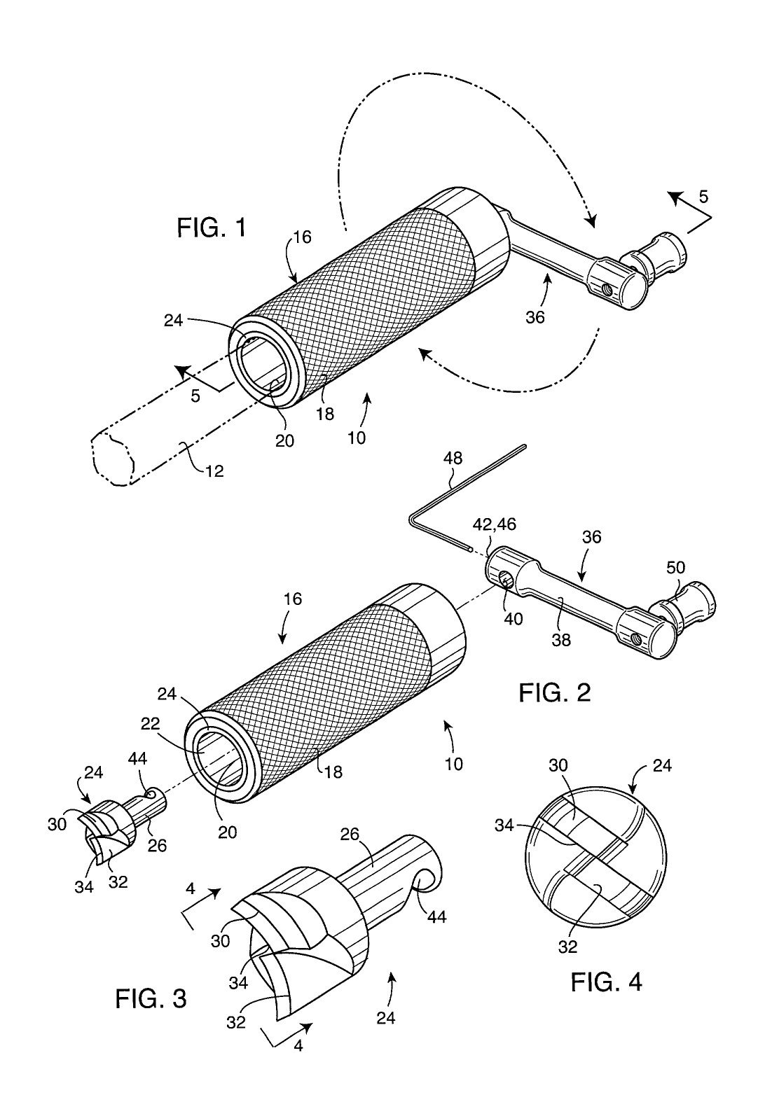

With reference to FIGS. 1 and 2, the device 10 includes a housing 16 which is typically cylindrical in shape and includes a roughened exterior surface 18 to facilitate manual gripping of the housing 16. The housing is typically comprised of a durable and sturdy material, such as steel or other metal. The housing 16 defines a central cylindrical bore 20 having an open end 22 which is configured to receive the end of the cue stick 12 bearing the cue tip 14. Typically, an insert is fixed within the housing 16 adjacent to the open end 22 and comprised of a material such as plastic to guide the tip 14 of the cue stick 12 within the housing 16 while preventing marring, scratching or other damage to the cue stick 12 and tip 14.

A cutter 24 is disposed within the bore 20, at an end of the housing 16 opposite the open end 22, so as to be rotatable. The cutter 24 is in the form of a bit having a shaft 26 which is insertable through an aperture 28 of the housing 16 on an end of the housing 16 opposite the open end 22 thereof. The aperture 28 is sized to hold the shaft 26 in proper alignment while also allowing the shaft 26 to rotate. Two blades 30 and 32 are formed on the cutter 24 opposite the shaft 26. The blades 30 and 32 each curve upwardly from a center line of the cutter 24 so that the two blades 30 and 32 cooperatively form a concave cutting edge 34. Of course, it should be understood by the reader that the cutter 24 can include a single blade, or multiple blades, so long as the cutter 24 is configured to form a convex shape to the tip 14 of the cue stick 12.

The device 10 includes a handle 36 which is attached to the shaft 26 of the cutter 24. The handle 36 can be turned, as illustrated in FIGS. 1 and 6, to rotate the cutter 24 and shape the tip 14 of the cue stick 12. The handle 36 includes an elongated arm 38 having an aperture 40 extending into an end of the arm 38 transverse to the longitudinal axis of the arm 38. This aperture 40 is sized to accept the shaft 26 of the cutter 24. Another aperture 42 which is internally threaded extends into the end of the arm 38 transverse to the aperture 40 so as to open into the aperture 40. The cutter shaft 26 includes a recess 44 which when inserted into aperture 40 is generally aligned with the internally threaded aperture 42. A set screw 46, or the like, can be threaded into aperture 42 until it resides within the cutter shaft recess 44, to hold the shaft 26 within the arm 38 of the handle 36. This can be done using an alien wrench 48 or the like. Removably attaching the cutter 24 to the handle 36 allows the cutter 24 to be removed from the housing 16 in the event that the blades 30 and 32 need to be sharpened, or the cutter 24 replaced as the cutting edge 34 dulls over time and repeated use.

The handle 36 also includes a finger grip 50 which is rotatably attached to an end of the arm 38 generally opposite the connection point of the cutter 24 with a pin 52 or various other means well known in the art so that the finger grip 50 is rotatable with respect to the arm 38. Such a configuration permits the handle 36 to be rotated with a minimal degree of effort or awkward repositioning of the hands and fingers of the user of the device 10.

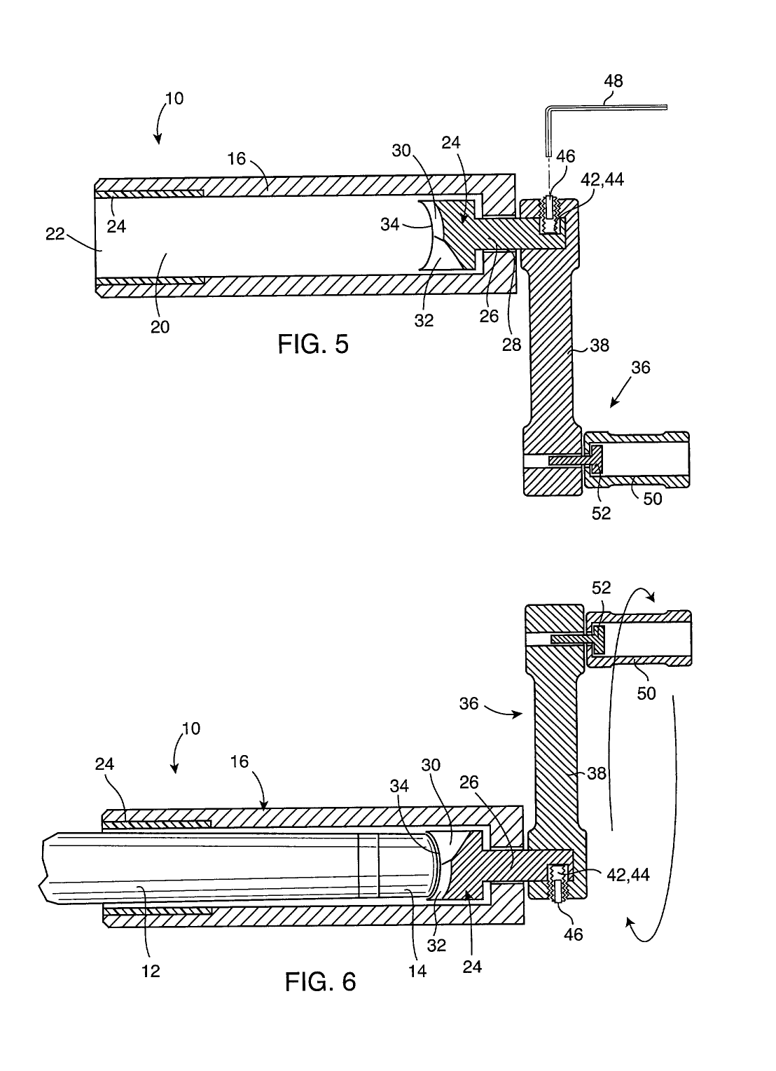

With reference now to FIGS. 5 and 6, in use, the cutter 24 is inserted into the bore 20 of the housing 16 so that the shaft 26 thereof extends rearward of the housing end. The handle 36 is attached to the cutter shaft 26 as described above. The tip 14 of the cue stick 12 is inserted through the open end 22 of the housing 16 and into the bore 20 until it contacts the cutting edge 34 of the cutter 24. The finger grip 50 is then grasped between the fingers and thumb of the user and the handle 36 is rotated, causing the cutter 24 to rotate and the concave cutting edge 34 thereof to form a convex shape to the tip 14. The cutter 24 is rotated until the exterior hitting surface of the tip 14 is properly reconditioned and shaped. Typically, this will occur after only a few rotations of the handle 36. The user of the device 10 will only want to remove a minimal amount of material from the tip 14 so as to prolong the useful life of the tip 14.

The advantages of the device 10 of the present invention will become immediately clear to those with skill in the art. When a tip 14 of a cue stick 12 becomes hardened or deformed, instead of replacing the tip which requires a great degree of skill and time, the tip 14 is merely shaved to recondition and reshape it. The device 10 is intuitive in use and does not require any training. Due to the simple design of the device 10 it can be manufactured relatively inexpensively. The device 10 can be used over a great deal of time as the cutter 24 can be removed and replaced as necessary.

Although the embodiment of the present invention has been described in detail for purposes of illustration, various modifications may be made without departing from the spirit and scope of the invention. Accordingly, the invention is not to be limited, except as by the appended claims.

What is claimed is:

1. A device for shaping and reconditioning a tip of a cue stick, comprising:
a hand-held housing defining a bore configured to receive the tip of the cue stick; and
a cutter disposed within the bore to engage the tip of the cue stick when inserted into the bore;
wherein the cutter forms a convex shape to the tip of the cue stick when the tip of the cue stick is placed in contact with the cutter and the cutter is rotated.

2. The device of claim 1, including a handle connected to the cutter for manually rotating the cutter.

3. The device of claim 1, wherein the handle is removably attached to the cutter, and the cutter is removably disposed within the housing.

4. The device of claim 1, wherein the cutter comprises a bit having a shaft extending outward of an aperture of the housing opposite an open end thereof, and a blade opposite the shaft.

5. The device of claim 3, wherein the blade comprise two blades, each blade being curved upwardly from a centerline of the bit so that the two blades cooperatively form a concave cutting edge.

6. The device of claim 4, including a handle removably attached to the shaft of the cutter by a screw inserted through an aperture of the handle and into a recess of the shaft.

7. The device of claim 1, wherein the housing is generally cylindrical and includes a roughened exterior surface to facilitate manual gripping.

8. The device of claim 1, including a guide insert disposed within the bore adjacent an open end of the housing.

9. A device for shaping and reconditioning a tip of a cue stick, comprising:
a hand-held housing defining a bore configured to receive the tip of the cue stick;
a cutter disposed within the bore to engage the tip of the cue stick when inserted into the bore, the cutter including a shaft extending outward of an aperture of the housing, and a blade opposite the shaft; and
a handle connected to the shaft of the cutter for manually rotating the cutter;
wherein the cutter forms a convex shape to the tip of the cue stick when the tip of the cue stick is placed in contact with the cutter and the cutter is rotated.

10. The device of claim 9, wherein the blade comprise two blades, each blade being curved upwardly from a centerline of the bit so that the two blades cooperatively form a concave cutting edge.

11. The device of claim 9, wherein the handle is removably attached to the cutter and the cutter is removably disposed in the housing.

12. The device of claim 11, wherein the handle is removably attached to the shaft of the cutter by a screw inserted through an aperture of the handle and into a recess of the shaft.

13. The device of claim 9, wherein the housing is generally cylindrical and includes a roughened exterior surface to facilitate manual gripping.

14. The device of claim 9, including a guide insert disposed within the bore adjacent an open end of the housing.

15. A device for shaping and reconditioning a tip of a cue stick, comprising:
a hand-held housing defining a bore configured to receive the tip of the cue stick;
a cutter removably disposed within the bore to engage the tip of the cue stick when inserted into the bore, the cutter including a shaft extending outward of an aperture of the housing, and two blades opposite the shaft, each blade being curved upwardly from a centerline of the bit so that the two blades cooperatively form a concave cutting edge; and
a handle removably connected to the shaft of the cutter for manually rotating the cutter;
wherein the cutter forms a convex shape to the tip of the cue stick when the tip of the cue stick is placed in contact with the cutter and the cutter is rotated.

16. The device of claim 15, wherein the handle is removably attached to the shaft of the cutter by a screw inserted through an aperture of the handle and into a recess of the shaft.

17. The device of claim 15, wherein the housing is generally cylindrical and includes a roughened exterior surface to facilitate manual gripping.

18. The device of claim 15, including a guide insert disposed within the bore adjacent an open end of the housing.
